(19) United States
(12) Patent Application Publication
(10) Pub. No.: US 2007/0167346 A1
(43) Pub. Date: Jul. 19, 2007

(54) Foam control compositions

(76) Inventors: Serge Creutz, Rocourt (BE); Kenneth Christopher Fey, Midland, MI (US); Alain Hilberer, Recquignies (FR); Jean-Paul Lecomte, Auderghem (BE); George C. Sawicki, Wales (GB)

Correspondence Address: DOW CORNING CORPORATION CO1232, 2200 W. SALZBURG ROAD, P.O. BOX 994, MIDLAND, MI, 48686-0994, US

(21) Appl. No.: 10/581,435

(22) PCT Filed: Dec. 9, 2004
(86) PCT No.: PCT/US04/41372

§ 371 Date: Nov. 30, 2006

(30) Foreign Application Priority Data
Dec. 17, 2003 (GB) 0329190.3

(51) Int. Cl. C11D 3/02

(52) U.S. Cl. 510/511

(57) ABSTRACT

A foam control composition contains a liquid polymer of an unsaturated hydrocarbon, a branched siloxane resin, and a particulate filler which is insoluble in the liquid hydrocarbon polymer. The foam control composition can additionally contain a polysiloxane fluid.

This invention is concerned with foam control compositions for use in aqueous compositions which are liable to foam.

In many aqueous systems which are used e.g. in food processes, textile dyeing, paper production, sewage treatment and cleaning applications, the production of foam needs to be controlled or prevented. It is important to keep the foam formation to an acceptable level when laundering is performed in automatic washing machines, especially front loading machines. Excessive foam would cause overflow of the washing liquor onto the floor as well as reduction in the efficiency of the laundering operation itself. The foam control compositions of the invention can be added to detergent compositions to inhibit excessive foaming when the detergent is used in washing, or to aqueous media in food processes, textile dyeing, paper production or sewage treatment which are likely to foam.

The most successful foam control agents, especially for detergents, are based on silicones. Examples are described in U.S. Pat. No. 5,767,053, U.S. Pat. No. 6,521,586 and U.S. Pat. No. 5,387,364. U.S. Pat. No. 6,521,587 describes a foam control agent, comprising an organopolysiloxane material having at least one silicon-bonded aralkyl substituent, a water-insoluble organic fluid, an organosilicon resin and a hydrophobic filler. It is preferred that the water-insoluble organic fluid is miscible with the organopolysiloxane fluid at the operating temperature of the foam control agent.

There has been some demand for foam control agents containing a reduced amount of organopolysiloxane. U.S. Pat. No. 5,693,256 describes a foam control agent comprising 100 parts by weight of a water-insoluble organic liquid, from 0.1 to 20 parts by weight of a first hydrophobic filler and 0.1 to 20 parts by weight of a second hydrophobic filler, which may be a siloxane resin, said hydrophobic fillers being insoluble in the water-insoluble organic liquid. EP-B-687724 describes a foam control agent comprising 100 parts by weight of a water-insoluble organic liquid, from 0.1 to 20 parts by weight of a hydrophobic filler that is insoluble in the organic liquid and 0.1 to 20 parts by weight of an organosilicon resin that is at least partially soluble in the organic liquid.

A foam control composition according to the invention comprises a liquid polymer of an unsaturated hydrocarbon, a branched siloxane resin, and a particulate filler which is insoluble in the liquid hydrocarbon polymer.

The preferred liquid hydrocarbon polymer is polyisobutene, also known as polyisobutylene or poly(2-methylpropene). Other liquid polymers of butene isomers can be used, for example a polymer of butene-1 and/or butene-2, as can other liquid hydrocarbon polymers such as polyisoprene. The liquid hydrocarbon polymer preferably has a molecular weight in the range 200 to 1500.

The branched siloxane resin and preferably consists of siloxane units of the formula R′ₐSiO_{4-a/2} wherein R′ denotes a hydroxyl, hydrocarbon or hydrocarbonoxy group, and wherein a has an average value of from 0.5 to 2.4. It preferably consists of monovalent trihydrocarbonsiloxy (M) groups of the formula R″₃SiO_{1/2} and tetrafunctional (Q) groups SiO_{4/2} wherein R″ denotes a monovalent hydrocarbon group. The number ratio of M groups to Q groups is preferably in the range 0.4:1 to 2.5:1 (equivalent to a value of a in the formula R′ₐSiO_{4-a/2} of 0.86 to 2.15), more preferably 0.4:1 to 1.1:1 and most preferably 0.5:1 to 0.8:1 (equivalent to a=1.0 to a=1.33). The branched siloxane resin is preferably a solid at room temperature. The molecular weight of the resin can be increased by condensation, for example by heating in the presence of a base. The base can for example be an aqueous or alcoholic solution of potassium hydroxide or sodium hydroxide, e.g. a solution in methanol or propanol. A resin comprising M groups, trivalent R″SiO_{3/2} (T) units and Q units can alternatively be used, or up to 20% of units in the branched siloxane resin can be divalent units R″₂SiO_{2/2}. The group R″ is preferably an alkyl group having 1 to 6 carbon atoms, for example methyl or ethyl, or can be phenyl. It is particularly preferred that at least 80%, most preferably substantially all, R″ groups present are methyl groups. The resin may be a trimethyl-capped resin. Other hydrocarbon groups may also be present, e.g. alkenyl groups present for example as dimethylvinylsilyl units, most preferably not exceeding 5% of all R″ groups. Silicon bonded hydroxyl groups and/or alkoxy, e.g. methoxy, groups may also be present.

The particulate filler is generally solid at 100° C. and can for example be silica, preferably with a surface area as measured by BET measurement of at least 50 m²/g., titania, ground quartz, alumina, an aluminosilicate, an organic wax, e.g. polyethylene wax or microcrystalline wax, zinc oxide, magnesium oxide, a salt of an aliphatic carboxylic acids, a reaction product of an isocyanate with an amine, e.g. cyclohexylamine, or an high melting (above 100° C.) alkyl amide such as ethylenebisstearamide or methylenebisstearamide. Mixtures of two or more of these can be used. The filler is preferably hydrophobic. Some of the fillers mentioned above are not hydrophobic in nature, but can be used if made hydrophobic. This could be done either in situ (i.e. when dispersed in the liquid hydrocarbon polymer), or by pre-treatment of the filler prior to mixing with the liquid hydrocarbon polymer. A preferred filler is silica which is made hydrophobic. Preferred silica materials are those which are prepared by heating, e.g. fumed silica, or precipitation. The silica filler may for example have an average particle size of 0.5 to 50 μm, preferably 2 to 30 and most preferably 5 to 25 μm. It can be made hydrophobic by treatment with a fatty acid, but is preferably done by the use of methyl substituted organosilicon materials such as dimethylsiloxane polymers which are end-blocked with silanol or silicon-bonded alkoxy groups, hexamethyldisilazane, hexamethyldisiloxane or organosilicon resins containing (CH₃)₃SiO_{1/2} groups. Hydrophobing is generally carried out at a temperature of at least 100° C. Mixtures of fillers can be used, for example a highly hydrophobic silica filler such as that sold under the Trade Mark ‘Sipemat D10’ can be used together with a partially hydrophobic silica such as that sold under the Trade Mark ‘Aerosil R972’.

In one preferred embodiment of the invention, the branched siloxane resin is soluble in the liquid hydrocarbon polymer. For a branched siloxane resin consisting mainly of trimethylsiloxy groups and Q or T branching units, and a liquid hydrocarbon polymer such as polyisobutene, the resin is generally soluble in the liquid hydrocarbon polymer if the liquid hydrocarbon polymer has a molecular weight in the range 200 to 500. Branched siloxane resins in which residual hydroxyl groups are capped with methyl have clear solution compatibility with liquid hydrocarbon polymer of higher molecular weight in this range than resins that have not been capped. Polyisobutenes of higher molecular weight, for example 500 to 1500, can also be used to make effective foam control compositions although branched siloxane resins are usually insoluble in these polyisobutenes of higher molecular weight. The liquid hydrocarbon polymer can be a blend of polymers; for example polyisobutene of Mw 750 can be a single polymer comprising molecules whose molecular weight is distributed about 750 or can be a blend of polyisobutenes characterized by the same viscosity.

The branched siloxane resin is preferably present at least 1%, more preferably at least 2% by weight based on the liquid hydrocarbon polymer, up to 40%, preferably up to 20%. For most antifoam uses it is preferred that the branched siloxane resin is present at 2 to 10% by weight based on the liquid hydrocarbon polymer.

The amount of hydrophobic filler in the foam control composition of the invention is preferably 0.5-50% by weight based on the polydiorganosiloxane fluid, more preferably from 1 up to 10 or 15% and most preferably 2 to 8%.

The blend of liquid hydrocarbon polymer, branched siloxane resin, and particulate filler is an effective foam control agent for many uses even when substantially free of polydiorganosiloxane fluid, particularly in controlling foam in aqueous media in food processes, textile dyeing, paper production or sewage treatment or in liquid detergent compositions.

The blend of liquid hydrocarbon polymer, branched siloxane resin, and particulate filler may further contain a substantially non-polar organic material of melting point 35 to 100° C. which is at least partially miscible with the liquid hydrocarbon polymer. The non-polar organic material generally enhances the effectiveness of foam control achieved by the blend. A preferred non-polar organic material of melting point 35 to 100° C. comprises an organic polyol ester which is a polyol substantially fully esterified by carboxylate groups each having 7 to 36 carbon atoms. The polyol ester is preferably a glycerol triester or an ester of a higher polyol such as pentaerythritol or sorbitol, but can be a diester of a glycol such as ethylene glycol or propylene glycol, preferably with a fatty acid having at least 14 carbon atoms, for example ethylene glycol distearate. Examples of preferred glycerol triesters are glycerol tripalmitate, which is particularly preferred, glycerol tristearate and glycerol triesters of saturated carboxylic acids having 20 or 22 carbon atoms such as that sold under the Trade Mark ‘Synchrowax HRC’.

Alternative suitable polyol esters are esters of pentaerythritol such as pentaerythritol tetrabehenate and pentaerythritol tetrastearate. The polyol ester can advantageously contain fatty acids of different chain length, which is common in natural products. Most preferably the polyol ester is substantially fully esterified by carboxylate groups each having 14 to 22 carbon atoms. By “substantially fully esterified” we mean that for a diol such as ethylene glycol or a triol such as glycerol, at least 90% and preferably at least 95% of the hydroxyl groups of the polyol are esterified. Higher polyols, particularly those such as pentaerythritol which show steric hindrance, may be “substantially fully esterified” when at least 70 or 75% of the hydroxyl groups of the polyol are esterified; for example pentaerythritol tristearate has the effect of a fully esterified polyol ester. The additive composition can comprise a mixture of polyol esters, for example a mixture containing carboxylate groups of different carbon chain length such as glyceryl tristearate and glyceryl tripalmitate, or glyceryl tristearate and Synchrowax HRC, or ethylene glycol distearate and Synchrowax HRC. Foam control compositions containing mixtures of two polyol esters in the additive composition may give greater foam control efficiency than compositions containing either polyol ester alone as the additive.

The non-polar organic material of melting point 35 to 100° C. can alternatively be a hydrocarbon wax, for example it can comprise at least one paraffin wax, optionally blended with microcrystalline wax, for example the wax sold under the Trade Mark ‘Cerozo’

The blend of liquid hydrocarbon polymer, branched siloxane resin, particulate filler and non-polar organic material of melting point 35 to 100° C. may further contain a component which contains groups more polar than the groups present in the polyol ester non-polar organic material. The more polar group preferably contains an active hydrogen atom, that is one liable to undergo hydrogen bonding. Examples of more polar groups are unesterified—OH groups (alcohol or phenol groups), unesterifed —COOH groups, amide groups or amino groups. The more polar component may have a melting point of at least 35° C., for example in the range 45-110° C., or may have a lower melting point, for example it may be liquid provided that the mixture of the non-polar and more polar components has a melting point of at least 35° C. The more polar component is preferably miscible with the polyol ester and may also be miscible with the liquid hydrocarbon polymer.

Examples of more polar components are fatty alcohols, ethoxylated fatty alcohols, ethoxylated fatty acids, ethoxylated alkyl phenols and partial esters of polyols such as monoesters or diesters of glycerol and a carboxylic acid having 8 to 30 carbon atoms, for example glycerol monostearate, sorbitan monostearate, glycerol monolaurate or glycerol distearate, and mixtures thereof, alkyl phenols having one or more alkyl substituent and preferably containing a total of 6 to 12 carbon atoms in the alkyl substituent or substituents attached to the phenol nucleus, for example octylphenol or nonylphenol or di(t-butyl)phenol, fatty acids having 8 to 36 carbon atoms, for example stearic acid, palmitic acid, behenic acid, oleic acid and/or 12-hydroxystearic acid, monoamides of fatty acids having 12 to 36 carbon atoms, for example stearamide, or alkyl amines having 8 to 30 carbon atoms.

The substantially non-polar material of melting point 35 to 100° C. and the more polar component can be present in weight ratio 5:95 to 95:5.

The additive composition, comprising the substantially non-polar material of melting point 35 to 100° C. and optionally the more polar component, is preferably present in the foam control composition at 10-200% by weight based on the liquid hydrocarbon polymer, most preferably 20 up to 100 or 120%.

The organic compounds of melting point 35 to 100° C. which have been described above as ‘the more polar component’ can alternatively be used as an additive to the blend of liquid hydrocarbon polymer, branched siloxane resin, particulate filler in place of the non-polar organic material, although this is less preferred.

The composition of the invention is also useful in enhancing the efficiency of foam control agents based on a polydiorganosiloxane fluid such as an organopolysiloxane material having at least one silicon-bonded aralkyl substituent. Thus according to another aspect of the invention a foam control composition comprises a liquid polymer of an unsaturated hydrocarbon, a branched siloxane resin, and a particulate filler which is insoluble in the liquid hydrocarbon polymer, and additionally 10 to 100% by weight based on the liquid hydrocarbon polymer of a polysiloxane fluid comprising at least 10% diorganosiloxane units of the formula 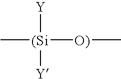
and up to 90% diorganosiloxane units of the formula 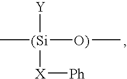
wherein X denotes a divalent aliphatic organic group bonded to silicon through a carbon atom; Ph denotes an aromatic group; Y denotes an alkyl group having 1 to 4 carbon atoms; and Y′ denotes an aliphatic hydrocarbon group having 1 to 24 carbon atoms. Such a foam control composition has enhanced efficiency over known high performance foam control agents based on organopolysiloxane materials having at least one silicon-bonded aralkyl substituent, in particular in foaming systems containing a nonionic surfactant.

The liquid hydrocarbon polymer to be used in a foam control composition also containing a polysiloxane fluid preferably has a molecular weight in the range 500 to 1500. Liquid hydrocarbon polymers such as polyisobutene having a molecular weight of 750 or above are usually immiscible with polysiloxane fluids, particularly polydiorganosiloxanes having at least one silicon-bonded aralkyl substituent. We have found, surprisingly, that partial substitution of a polydiorganosiloxane by an immiscible polyisobutene oil such as that sold under the Trade Mark ‘Glissopal 1000’ (molecular weight 1000) leads to a large increase in defoaming persistence in certain nonionic surfactant solutions. Liquid hydrocarbon polymers such as polyisobutene of somewhat lower molecular weight, for example 350 to 550, can also be effective in improving defoaming persistence.

The diorganosiloxane units containing a —X-Ph group preferably comprise 5 to 40%, of the diorganosiloxane units in the fluid of the formula 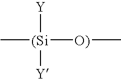
and up to 90% diorganosiloxane units of the formula

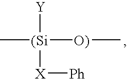

The group X is preferably a divalent alkylene group having from 2 to 10 carbon atoms, most preferably 2 to 4 carbon atoms, but can alternatively contain an ether linkage between two alkylene groups or between an alkylene group and —Ph, or can contain an ester linkage. Ph is most preferably a phenyl group, but may be substituted for example by one or more methyl, methoxy, hydroxy or chloro group, or two substituents R may together form a divalent alkylene group, or may together form an aromatic ring, resulting in conjunction with the Ph group in e.g. a naphthalene group. A particularly preferred X—Ph group is 2-phenylpropyl —CH₂—CH(CH₃)—C₆H₅. The group Y′ preferably has 1 to 18, most preferably 2 to 16, carbon atoms, for example ethyl, methyl, propyl, isobutyl or hexyl. Mixtures of different groups Y′ can be present, for example a mixture of dodecyl and tetradecyl. Mixtures of alkyl groups Y′ can be used. Other groups may be present, for example haloalkyl groups such as chloropropyl, acyloxyalkyl or alkoxyalkyl groups or aromatic groups such as phenyl bonded direct to Si. The polysiloxane fluid containing —X—Ph groups may be a substantially linear siloxane polymer or may have some branching, for example branching in the siloxane chain by the presence of some tri-functional siloxane units, or branching by a multivalent, e.g. divalent or trivalerit, organic or silicon-organic moiety linking polymer chains, as described in U.S. Pat. No. 6,521,587.

The foam control compositions according to the invention may be made by combining the liquid hydrocarbon polymer, the hydrophobic filler and the branched siloxane resin in any convenient way. The liquid hydrocarbon polymer, the hydrophobic filler and the organosilicon resin are preferably mixed together under shear. Where the filler needs to be made hydrophobic in situ, the manufacturing process includes a heating stage, preferably under reduced pressure, in which the filler and the treating agent are mixed together in part or all of the liquid hydrocarbon polymer, in the presence of a suitable catalyst if required.

The foam control composition of the present invention may be supported on a particulate carrier, particularly when the composition is to be used in a powdered product such as a detergent powder. Examples of carriers and/or supports are zeolites, for example Zeolite A or Zeolite X, other aluminosilicates or silicates, for example magnesium silicate, phosphates, for example powdered or granular sodium tripolyphosphate, sodium sulphate, sodium carbonate, for example anhydrous sodium carbonate or sodium carbonate monohydrate, sodium perborate, a cellulose derivative such as sodium carboxymethylcellulose, granulated starch, clay, sodium citrate, sodium acetate, sodium bicarbonate, sodium sesquicarbonate and native starch. The liquid hydrocarbon polymer containing the hydrophobic filler and the branched siloxane resin is preferably deposited on the carrier particles in non-aqueous liquid form, for example a temperature in the range 40-100° C.

In an alternative process, the liquid hydrocarbon polymer, the hydrophobic filler and the branched siloxane resin and the non-polar additive if present are emulsified in water and the resulting aqueous emulsion is deposited on the carrier particles. The supported foam control composition is preferably made by an agglomeration process in which the foam control composition is sprayed onto the carrier particles while agitating the particles. The particles are preferably agitated in a high shear mixer through which the particles pass continuously. In one preferred process, the particles are agitated in a vertical, continuous high shear mixer in which the foam control composition is sprayed onto the particles. One example of such a mixer is a Flexomix mixer supplied by Hosokawa Schugi.

The supported foam control composition may additionally include a water-soluble or water-dispersible binder to improve the stability of the particles. Examples of binders are polycarboxylates, for example polyacrylic acid or a partial sodium salt thereof or a copolymer of acrylic acid, for example a copolymer with maleic anhydride, polyoxyalkylene polymers such as polyethylene glycol, which can be applied molten or as an aqueous solution and spray dried, reaction products of tallow alcohol and ethylene oxide, or cellulose ethers, particularly water-soluble or water-swellable cellulose ethers such as sodium carboxymethylcellulose, or sugar syrup binders. The water-soluble or water-dispersible binder can be mixed with the foam control composition before being deposited on the carrier, but preferably is separately deposited on the carrier particles. In one preferred procedure the foam control composition is deposited on the carrier particles as a non-aqueous liquid at a temperature in the range 40-100° C. and the water-soluble or water-dispersible binder is at the same time or subsequently, or at both times, deposited on the carrier from a separate feed as an aqueous solution or dispersion.

The supported foam control composition may optionally contain a surfactant to aid dispersion of the foam control composition in the binder and/or to help in controlling the “foam profile”, that is in ensuring that some foam is visible throughout the wash without overfoaming. Examples of surfactants include silicone glycols, or fatty alcohol ether sulphate or linear alkylbenzene sulphonate, which may be preferred with a polyacrylic acid binder. The surfactant can be added to the foam control composition undiluted before the silicone is deposited on the carrier, or the surfactant can be added to the binder and deposited as an aqueous emulsion on the carrier.

The foam control composition can alternatively be provided in the form of an oil-in-water emulsion using any of the surfactants described in U.S. Pat. No. 6,521,587. Alternatively the foam control agent can be provided as a water-dispersible composition in a water-dispersible vehicle such as a silicone glycol or in another water-miscible liquid such as ethylene glycol, polyethylene glycol, propylene glycol, a copolymer of ethylene glycol and propylene glycol, an alcohol alkoxylate, an alkoxyalkanol or hydroxyalkyl ether or an alkylphenol alkoxylate.

The foam control agents according to this invention are useful for reducing or preventing foam formation in aqueous systems, including foam generated by detergent compositions during laundering and foam generated in such processes as paper making and pulping processes, textile dyeing processes, cutting oil, coatings and other aqueous systems where surfactants may produce foam.

The following examples illustrate the invention. All parts and percentages are expressed by weight unless otherwise stated.

### EXAMPLE 1

90% polyisobutene of molecular weight 550 was blended with 6% ‘Sipemat D10’ (Trade Mark) hydrophobic treated silica and 4% of a MQ siloxane resin having a ratio of M groups to Q groups of 0.65 to form Antifoam Composition A. The siloxane resin was dispersed in, but did not dissolve in, the polyisobutene. Antifoam Composition A was deposited onto a sugar carrier to produce a supported foam control composition.

### EXAMPLE 2

65% Antifoam Composition A was blended with 35% ‘Synchrowax HRC’ to form Antifoam Composition B.

### EXAMPLE 3

80% polyisobutene of molecular weight 550 was blended with 20% polyisobutene of molecular weight 1000.90% of the resulting polyisobutene blend was blended with 6% Sipernat D10 and 4% of the MQ siloxane resin described in Example 1.65% of the resulting composition was blended with 35% ‘Synchrowax HRC’ to form Antifoam Composition C.

### EXAMPLE 4

50% polyisobutene of molecular weight 550 was blended with 50% polyisobutene of molecular weight 1000.90% of the resulting polyisobutene blend was blended with 6% Sipemat D10 and 4% of the MQ siloxane resin described in Example 1.65% of the resulting composition was blended with 35% ‘Synchrowax HRC’ to form Antifoam Composition D.

### EXAMPLE 5

65% Antifoam Composition A was blended with 28% ‘Synchrowax HRC’ and 7% octylphenol to form Antifoam Composition E.

### EXAMPLE 6

65% Antifoam Composition A was blended with 35% glyceryl monostearate (90% pure) to form Antifoam Composition F. Antifoam Compositions B, C, D, E and F were each sprayed onto sodium carbonate powder in a granulating mixer to produce a supported foam control composition containing about 16% of the active foam control composition.

Comparative Tests

Supported Antifoam Compositions A, B, C, D, E and F and comparative foam control agents G1 to G3 were tested in a powder detergent formulation which comprised 327 parts by weight zeolite, 95 parts of a 55% aqueous solution of sodium dodecylbenzenesulphonate, 39 parts ethoxylated lauryl stearyl alcohol, 39 parts sodium sulphate, 125 parts sodium carbonate and 125 parts sodium perborate. The comparative foam control agents were commercially used supported foam control compositions based on polydiorganosiloxane fluids containing hydrophobic silica. G1 and G2 used a zeolite carrier and G3 used a starch carrier. Each supported foam control composition was used at about 1% by weight of the detergent powder (0.15% by weight active foam control compound based on detergent powder). The evaluation was made in a Miele 934 front loading washing machine, loaded with 16 cotton towels, 100 g of the detergent formulation, 17 litres of water of 9 degree German hardness using a wash cycle of 65 minutes at 40° C. or 95° C. The foam height was measured every 5 minutes during the wash cycle and recorded, where the value indicated is the foam height in the washing machine, with 100% referring to the fact that the window of the machine was full of foam, 50%, that is was half full of foam. The results are described in Table 1 below.

TABLE 1

| | | | | | % Foam | | | | | | | | | | | | | |
|---|---|---|---|---|---|---|---|---|---|---|---|---|---|---|---|---|---|---|
| Compo- | | % | | Temp | height with | | | | | | | | | | | | | |
| sition | Carrier | Dosage | % Active | C. | time (mins) | 5 | 10 | 15 | 20 | 25 | 30 | 35 | 40 | 45 | 50 | 55 | 60 | 65 |
| A | Sugar | 0.15 | | 40 | 0 | 0 | 0 | 0 | 10 | 10 | 20 | 20 | 40 | 40 | 50 | 60 | 60 | 60 |
| B | Soda Ash | 0.15 | 16.91 | 40 | 0 | 0 | 0 | 0 | 0 | 0 | 0 | 0 | 5 | 5 | 5 | 15 | 20 | 25 |
| C | Soda Ash | 0.15 | 16.44 | 40 | 0 | 60 | 50 | 60 | 50 | 50 | 50 | 40 | 50 | 50 | 50 | 50 | 50 | 50 |
| D | Soda Ash | 0.15 | 16.37 | 40 | 0 | 80 | 90 | 90 | 90 | 90 | 100 | 100 | 100 | 100 | 100 | 100 | 100 | 100 |
| B | Soda Ash | 0.15 | 16.91 | 95 | 0 | 0 | 0 | 0 | 0 | 0 | 0 | 0 | 0 | 0 | 0 | 0 | 10 | 20 |
| C | Soda Ash | 0.15 | 16.44 | 95 | 0 | 50 | 50 | 50 | 50 | 40 | 10 | 0 | 0 | 0 | 10 | 10 | 20 | 20 |
| D | Soda Ash | 0.15 | 16.37 | 95 | 0 | 90 | 90 | 100 | 100 | 90 | 60 | 0 | 0 | 0 | 20 | 10 | 10 | 10 |
| E | Soda Ash | 0.15 | 16.40 | 40 | 0 | 0 | 0 | 0 | 0 | 0 | 0 | 0 | 0 | 0 | 10 | 20 | 20 | 30 |
| E | Soda Ash | 0.15 | 16.40 | 95 | 0 | 0 | 0 | 0 | 0 | 0 | 0 | 0 | 0 | 10 | 20 | 30 | 30 | 40 |
| F | Soda Ash | 0.15 | 16.51 | 40 | 0 | 40 | 30 | 10 | 0 | 10 | 20 | 30 | 50 | 60 | 60 | 60 | 70 | 80 |
| G1 | Zeolite | 0.15 | 11.50 | 40 | 0 | 5 | 30 | 50 | 70 | 90 | 100 | 100 | 100 | 100 | 100 | 100 | 100 | 100 |
| G2 | Zeolite | 0.15 | 11.12 | 40 | 0 | 0 | 0 | 0 | 0 | 0 | 0 | 5 | 20 | 25 | 35 | 45 | 50 | 50 |
| G3 | Starch | 0.15 | 14.00 | 40 | 0 | 0 | 0 | 0 | 0 | 0 | 0 | 0 | 0 | 5 | 10 | 20 | 30 | 35 |
| F | Soda Ash | 0.15 | 16.51 | 95 | 0 | 50 | 30 | 10 | 20 | 20 | 20 | 30 | 40 | 50 | 50 | 40 | 40 | 40 |
| G1 | Zeolite | 0.15 | 11.50 | 95 | 0 | 0 | 40 | 60 | 90 | 90 | 100 | 100 | 100 | 100 | 100 | 100 | 100 | 100 |
| G2 | Zeolite | 0.15 | 11.12 | 95 | 0 | 0 | 0 | 0 | 0 | 0 | 10 | 10 | 10 | 10 | 20 | 10 | 0 | 0 |
| G3 | Starch | 0.15 | 14.00 | 95 | 0 | 0 | 0 | 0 | 0 | 0 | 0 | 50 | 100 | 100 | 100 | 100 | 100 | 100 |

The foam control compositions of the invention showed effective foam control at both 40° C. and 95° C. and were in some conditions more effective than the commercial comparative compositions.

### EXAMPLE 7

86% of a polydiorganosiloxane fluid comprising methyl ethyl siloxane groups and methyl 2-phenylpropyl siloxane groups was blended with 2% ‘Cabosil TS720’ (Trade Mark) hydrophobic treated silica and 12% of the branched siloxane resin used in Example 1 to form a silicone foam control agent. 50% of the silicone foam control agent was blended with 50% polyisobutene of molecular weight 1000 to form a foam control composition of the invention containing polyisobutene, hydrophobic silica, branched siloxane resin and polydiorganosiloxane fluid. The foam control composition was tested in ‘Triton X-100’ (Trade Mark) alkyl phenol ethoxylate surfactant. The silicone foam control agent is known to have a poor persistence in this surfactant.

Testing was done in the following way: 100 ml of 1% aqueous surfactant solution are placed in a 250 ml bottle; 20 μl of the antifoam is added with a micro-syringe and the bottle submitted to 15 s shake cycles (with a wrist-action shaker). After each shake cycle, one monitors the time for the produced foam to collapse to 10% of the free volume above the solution. The foam collapse time is plotted versus the number of shake cycles to show the evolution of defoaming activity with time. When the collapse time reaches 120 s we consider that the antifoam is deactivated. The silicone foam control agent was deactivated after 29 shake cycles. The foam control composition of the invention showed a foam collapse time of below 70 seconds even after 40 cycles. The polyisobutene alone showed no antifoam activity (no foam collapse).

### EXAMPLES 8 AND 9

Foam control compositions of the invention were prepared by blending 20% of the silicone foam control agent of Example 7 with 80% polyisobutene of molecular weight 1000 (Example 8) or 10% of the silicone foam control agent of Example 7 with 90% polyisobutene of molecular weight 1000 (Example 9)

When the foam control compositions of Examples 8 and 9 were tested in the shake cycle test, they showed an even more persistent effect than the composition of Example 8. The foam collapse time stayed below 80 seconds for 52 shake cycles (Example 8) and 54 shake cycles (Example 9).

1. A foam control composition comprising a liquid polyisobutene having a molecular weight in the range 200 to 1500, a branched siloxane resin, a particulate filler which is insoluble in the liquid polyisobutene, and an organic polyol ester which is a polyol substantially fully esterified by carboxylate groups each having 7 to 36 carbon atoms.

2. A foam control composition according to claim 1 characterized in that the liquid polyisobutene has a molecular weight in the range 200 to 500 and in that the branched siloxane resin is soluble in the liquid polyisobutene.

3. A foam control composition according to claim 1 characterised in that the branched siloxane resin consists of monovalent trihydrocarbonsiloxy (M) groups of the formula R″₃SiO_{1/2} and tetrafunctional (Q) groups SiO_{4/2} wherein R″ denotes an alkyl group and the number ratio of M groups to Q groups is in the range 0.4:1 to 1.1:1.

4. A foam control composition according to claim 1 characterised in that the particulate filler is a silica filler with an average particle size of from 0.5 to 30 μm.

5. A foam control composition according to claim 1 that is substantially free of polydiorganosiloxane fluid.

6. A foam control composition according to claim 1 that additionally comprises 10 to 100% by weight based on the liquid hydrocarbon polymer of a polysiloxane fluid comprising at least 10% diorganosiloxane units of the formula 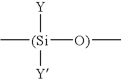
and up to 90% diorganosiloxane units of the formula 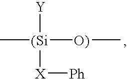
wherein X denotes a divalent aliphatic organic group bonded to silicon through a carbon atom; Ph denotes an aromatic group; Y denotes an alkyl group having 1 to 4 carbon atoms; and Y′ denotes an aliphatic hydrocarbon group having 1 to 24 carbon atoms.

7. A foam control agent according to claim 1 that is provided in the form of an oil-in-water emulsion.

8. A water-dispersible foam control composition comprising a foam control agent according to claim 1 dispersed in a water-dispersible carrier.

9. A granulated foam control agent comprising a foam control composition according to claim 1, supported on a particulate carrier.

10. A granulated foam control agent according to claim 18 characterized in that a water-soluble or water-dispersible binder is also deposited on the carrier particles.
